(19) United States
(12) Patent Application Publication
(10) Pub. No.: US 2026/0212193 A1
(43) Pub. Date: Jul. 23, 2026

(54) DOCUMENT CLASSIFICATION DEVICE USING LANGUAGE MODEL

(71) Applicant: NEC Corporation, Tokyo (JP)

(72) Inventors: Soma ONISHI, Tokyo (JP); Masanori TSUJIKAWA, Tokyo (JP); Daisaku SHIBATA, Tokyo (JP)

(73) Assignee: NEC Corporation, Tokyo (JP)

(21) Appl. No.: 19/447,043

(22) Filed: Jan. 13, 2026

(30) Foreign Application Priority Data
Jan. 23, 2025 (JP) 2025-009744

(51) Int. Cl. G06N 3/09

(52) U.S. Cl. CPC G06N 3/09

(57) ABSTRACT

A document classification device according to the present disclosure includes a prompt generation unit that generates, a prompt composed of a combination of a document and a rule, for each individual rule among a plurality of the rules for classifying the document into a preset class, and an inference unit that performs, with a language model, inference for each of the rules of the document by inputting each of the prompts to the language model. The information processing device of the present disclosure can be used for supporting decision-making in the medical field.

### INCORPORATION OF BASIC APPLICATION

The present invention claims the benefit of the priority of Japanese Patent Application No. 2025-009744 filed on January 23, 2025 in Japan, the contents of which are incorporated herein in its entirety by reference.

### TECHNICAL FIELD

The present disclosure relates to a document classification device using a language model.

### BACKGROUND ART

PTL 1 describes classifying documents using a language model. Specifically, in PTL 1, probabilities of respective document labels are estimated from a document using the language model, and the labels are aggregated from the probabilities.

PTL 1: Japanese Unexamined Patent Application Publication No. 2023-136771

### SUMMARY

However, as described in PTL 1, in a case where the probabilities of a plurality of the labels in the document are inferred, it is necessary to describe rules of all the labels in a prompt serving as an inference instruction for the language model. As a result, the prompt becomes longer, so that a problem arises in that the amount of calculation increases and the inference accuracy deteriorates.

Thus, one object of the present disclosure is to solve the above-described problem, that is, deterioration of inference accuracy in classification of documents using rules.

A document classification device using a language model according to one aspect of the present disclosure is configured to include

a prompt generation unit that generates a prompt composed of a combination of a document and a rule, for each individual rule among a plurality of the rules for classifying the document into a preset class, and

an inference unit that performs, with a language model, inference for each of the rules of the document by inputting each of the prompts to the language model.

A document classification method using a language model according to one aspect of the present disclosure is such that an information processing device performs

generating a prompt composed of a combination of a document and a rule, for each individual rule among a plurality of the rules for classifying the document into a preset class, and

performing, with a language model, inference for each of the rules of the document by inputting each of the prompts to the language model.

A program of one aspect of the present disclosure is configured to cause an information processing device to execute processing to

generate a prompt composed of a combination of a document and a rule, for each individual rule among a plurality of the rules for classifying the document into a preset class, and

perform, with a language model, inference for each of the rules of the document by inputting each of the prompts to the language model.

As a result of the configurations described above, the present disclosure can contribute to improvement of the inference accuracy in the document classification using rules.

### BRIEF DESCRIPTION OF THE DRAWINGS

FIG. 1 is a block diagram illustrating an example of a configuration of an information processing device according to the present disclosure;

FIG. 2 is a diagram illustrating an example of processing of the information processing device according to the present disclosure;

FIG. 3 is a diagram illustrating an example of processing of the information processing device according to the present disclosure;

FIG. 4 is a diagram illustrating an example of processing of the information processing device according to the present disclosure;

FIG. 5 is a diagram illustrating an example of processing by the information processing device according to the present disclosure;

FIG. 6 is a flowchart illustrating an example of a processing operation by the information processing device according to the present disclosure;

FIG. 7 is a diagram illustrating an example of processing by the information processing device according to the present disclosure;

FIG. 8 is a diagram illustrating an example of processing by the information processing device according to the present disclosure;

FIG. 9 is a diagram illustrating an example of processing by the information processing device according to the present disclosure;

FIG. 10 is a diagram illustrating an example of processing by the information processing device according to the present disclosure;

FIG. 11 is a diagram illustrating an example of processing by the information processing device according to the present disclosure;

FIG. 12 is a flowchart illustrating an example of a processing operation by the information processing device according to the present disclosure;

FIG. 13 is a diagram illustrating an example of processing by the information processing device according to the present disclosure;

FIG. 14 is a block diagram illustrating an example of a hardware configuration of the information processing device according to the present disclosure;

FIG. 15 is a block diagram illustrating an example of the configuration of the information processing device according to the present disclosure; and

FIG. 16 is a flowchart illustrating an example of a processing operation by the information processing device according to the present disclosure.

### EXAMPLE EMBODIMENT

### First example embodiment

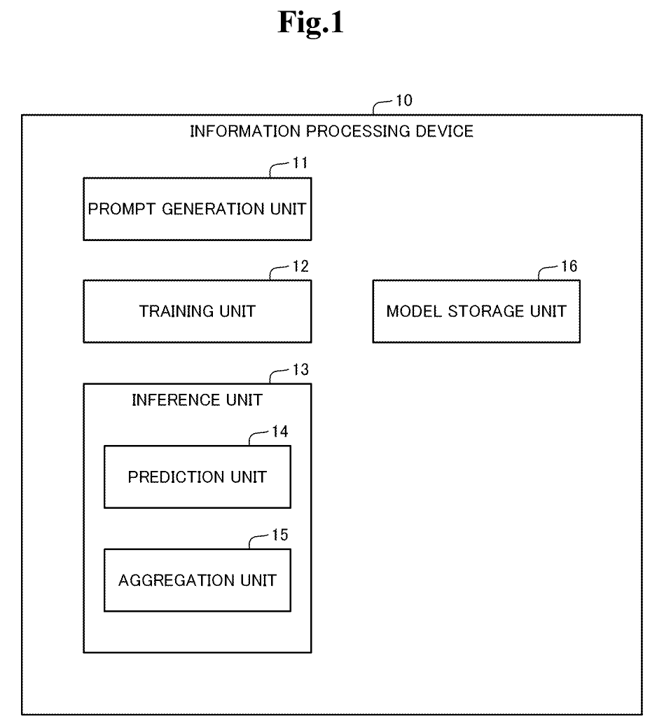

A first example embodiment of the present disclosure will be described with reference to the drawings. FIGS. 1 to 13 can be related to all the example embodiments.

As an example, an information processing device 10 of the present disclosure is utilized in such a way as to classify a document, such as an interpretation report of a malignant tumor of lung cancer, according to TNM classification. Here, the TNM classification of malignant tumors of lung cancer is an international standard for evaluating the degree of progression of cancer. “T” indicates the size and extent of the primary tumor, and the larger a numerical value, the larger the tumor, indicating that the tumor invades surrounding tissues. “N” indicates the presence or absence and area of metastasis to lymph nodes, and a larger numerical value indicates that the tumor has metastasized to more lymph nodes. “M” indicates the presence or absence of distant metastasis and indicates whether the cancer has spread to other parts of the body. Combining these pieces of information allows a stage (label) of the cancer to be determined, leading to an important index for making a treatment policy.

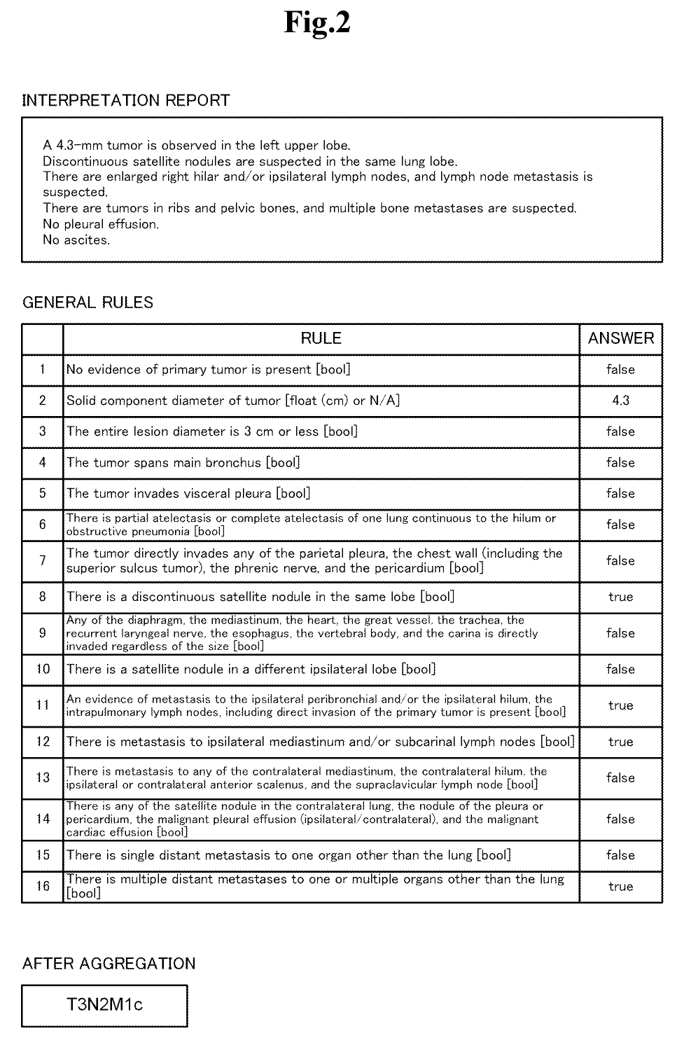

In the present example embodiment, the “interpretation report” being a document that is a classification target is assumed to be a document having a content as illustrated in FIG. 2 as an example. It is also assumed that rules for the above TNM-based classification of the interpretation report are, for example, “general rules” composed of 16 rules illustrated in FIG. 2. For example, Rule 1 is a rule with a content, such as “no evidence of tumor is present”, and is a rule of which answer to the content of the interpretation report can be “true” or “false”. For example, Rule 2 is a rule with a content, such as “solid component diameter of tumor”, and is a rule of which answer to the content of the interpretation report can be a “numerical value (cm)”. In the present example embodiment, it is assumed that the TNM classification for the content of the “interpretation report” is determined based on answers to the respective 16 rules. For example, a TNM label indicated by “AFTER AGGREGATION” in FIG. 2 is output.

Hereinafter, examples of a configuration and an operation of the information processing device 10 according to the present example embodiment will be described. The information processing device 10 is configured with one or a plurality of information processing devices including arithmetic devices and storage devices. As illustrated in FIG. 1, the information processing device 10 includes a prompt generation unit 11, a training unit 12, and an inference unit 13. The inference unit 13 includes a prediction unit 14 and an aggregation unit 15. Each function of the prompt generation unit 11, the training unit 12, the inference unit 13, the prediction unit 14, and the aggregation unit 15 can be achieved by the arithmetic device executing a program, stored in the storage device, for achieving each function. The information processing device 10 also includes a model storage unit 16 achieved by the storage device.

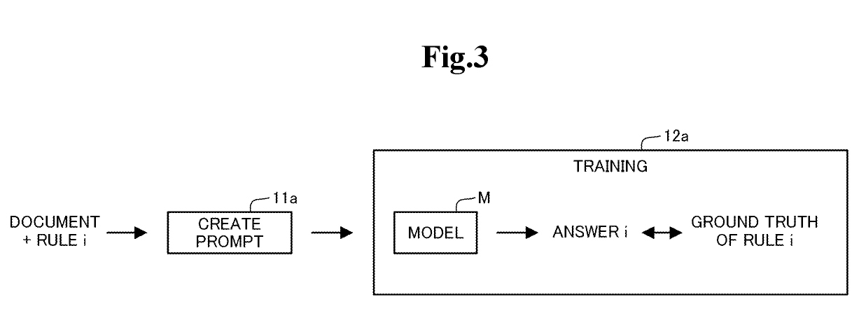

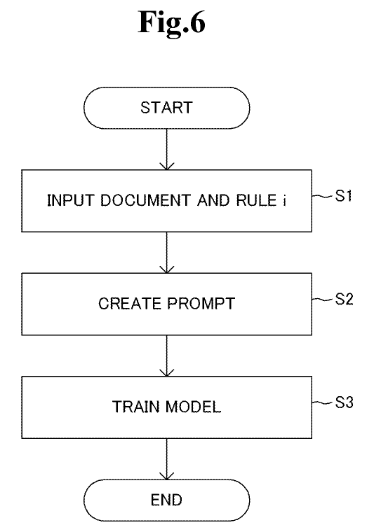

First, configurations and operations of the prompt generation unit 11 and the training unit 12 will be described as a configuration and an operation at the time of training of a language model by the information processing device 10. FIGS. 3 to 5 illustrate examples of processing by the information processing device 10, and FIG. 6 illustrates a flowchart of a processing operation by the information processing device 10.

As illustrated in FIG. 3, the prompt generation unit 11 receives an input of the interpretation report being a document that is a learning target and the rules used at the time of the TNM-based classification (step S1 in FIG. 6). At this time, as illustrated in FIG. 2, the prompt generation unit 11 may collectively receive inputs of all 16 rules that are the general rules, or may individually receive an input of each rule.

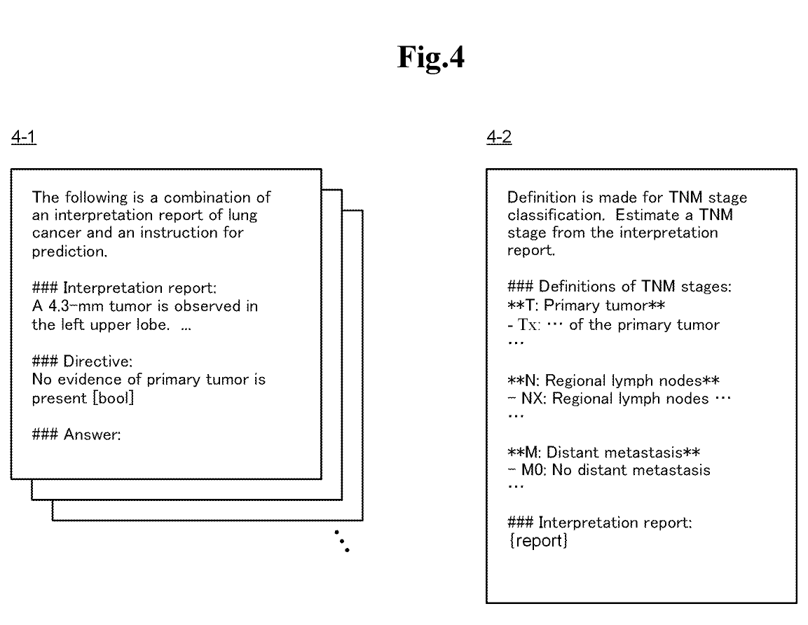

The prompt generation unit 11 then generates a prompt composed of a combination of the interpretation report and one of the rules (reference sign 11a in FIG. 3, step S2 in FIG. 6). The prompt is a command for the language model being a target of machine learning, and in the present example embodiment, as illustrated in FIG. 4 (4-1), the prompt is composed of the combination of the “interpretation report” and the “rule” that is a directive for the language model to predict the content of the “interpretation report”. That is, the prompt generation unit 11 generates, as the prompt, a command instructing the language model to perform prediction (inference), regarding the content of the “interpretation report” contained in the prompt, for the content of the “rule” contained in the prompt, and to output an answer that is a prediction result (inference result).

At this time, the prompt generation unit 11 generates the prompt in such a way as to form the combination of one rule and the interpretation report with a correspondence relation. Thus, when there are 16 rules as illustrated in FIG. 2, 16 prompts are generated. Specifically, generated are a prompt composed of a combination of the interpretation report and Rule 1, a prompt composed of a combination of the interpretation report and Rule 2, ..., and a prompt composed of a combination of the interpretation report and Rule 16.

As described above, one prompt is generated for each rule, which makes it possible to reduce an increase in prompt length, and to reduce memory usage in the information processing device 10 and an amount of calculation by the language model according to the prompt, which will be described later. That is, each one of the prompts as illustrated in FIG. 4 (4-1) can contribute to a decrease in the memory usage and the amount of calculation as compared with a case where the general rules that are all 16 rules are contained in one prompt as illustrated in FIG. 4 (4-2). Specifically, with a general Transformer-based model, when the general rules are first added to a prompt, an amount of calculation and memory usage increase from O(N^2) to O((R+N)^2). Here, O (order) is an index representing the amount of calculation. That is, in the Transformer-based model, the amount of calculation increases in proportion to the square of the length of the prompt. N is an original prompt length, and R+N is a prompt length when the general rules are added to the prompt. On the other hand, in the present example embodiment, since the amount of calculation and the memory usage are O(k∙(r+N)^2), the amount of calculation is generally lower than O((R+N)^2), where k is the number of rules, and r+N is a prompt length when a certain rule in the general rules is added to the prompt.

The training unit 12 inputs the prompt created with a correspondence relation with each rule as described above to a language model M, and trains the language model M via machine learning (reference sign 12a in FIG. 3, step S3 in FIG. 6) by using ground truth data relevant to each rule and an answer, output from the language model M, to each rule regarding the interpretation report. For example, the language model M is trained via machine learning in such a way as to, when the prompt relevant to Rule 1 is input to the language model, minimize an error between the answer, output from the language model, to Rule 1 for the interpretation report, and ground truth data that is prepared in advance and is relevant to Rule 1 for the interpretation report. Similarly, the language model M is trained via machine learning in such a way as to, when the prompt relevant to Rule 2 is input to the language model, minimize an error between the answer, output from the language model, to Rule 2 for the interpretation report, and ground truth data that is prepared in advance and is relevant to Rule 2 for the interpretation report. Such machine learning is performed using the respective prompts and respective pieces of ground truth data relevant to all rules. At this time, the answers and the pieces of ground truth data are values according to the contents of the rules, and are, for example, as illustrated in FIG. 2, values, such as “true”, “false”, and a “numerical value”, and the machine learning is performed in such a way as to minimize errors between the answers and the pieces of ground truth data. The training unit 12 then stores the language model M subjected to the machine learning in the model storage unit 16.

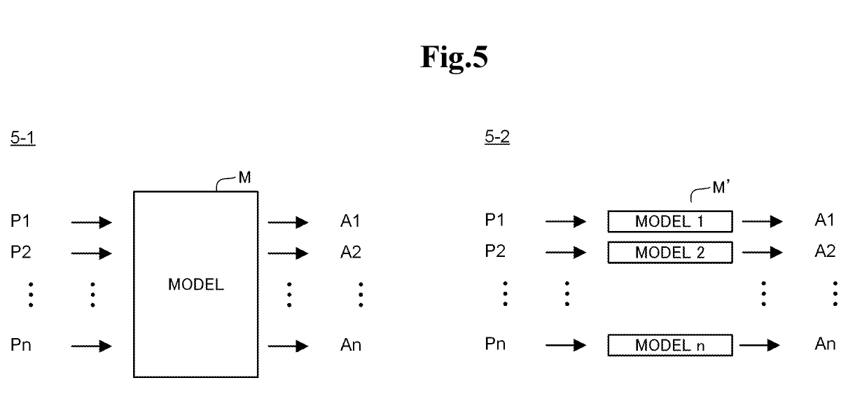

The training unit 12 may train one language model M via machine learning or may train, via machine learning, a language model group M’ composed of language models prepared for the respective rules with correspondence relations. Specifically, as illustrated in FIG. 5 (5-1), the language model M may be trained via machine learning in such a way as to input, to one language model M, each of prompts P1 to Pn relevant to each of the rules and minimize an error between each of answers A1 to An relevant to each of the rules and each piece of the ground truth data. Alternatively, as illustrated in FIG. 5 (5-2), the language models 1 to n may each be trained via machine learning in such a way as to input the prompts P1 to Pn relevant to the respective rules to language models 1 to n relevant to the respective rules, and minimize an error between each of the answers A1 to An relevant to each of the rules and each piece of the ground truth data.

The language model M subjected to the machine learning as described above is configured to output an answer that is an inference result to each rule by inputting the prompt relevant to each rule described above.

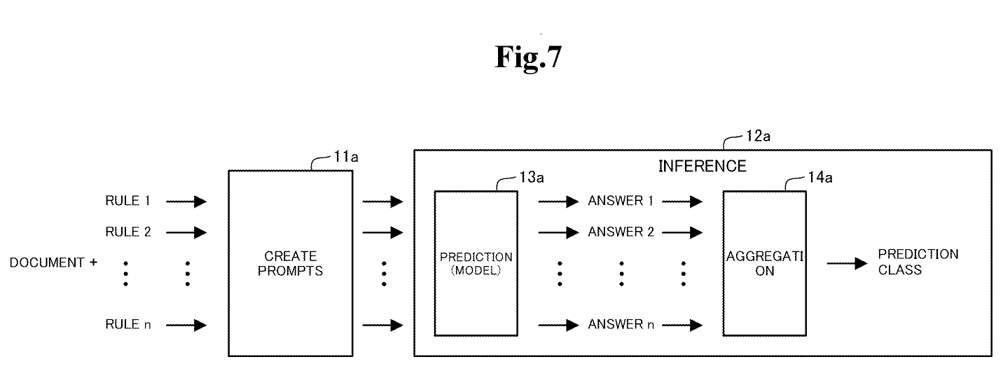

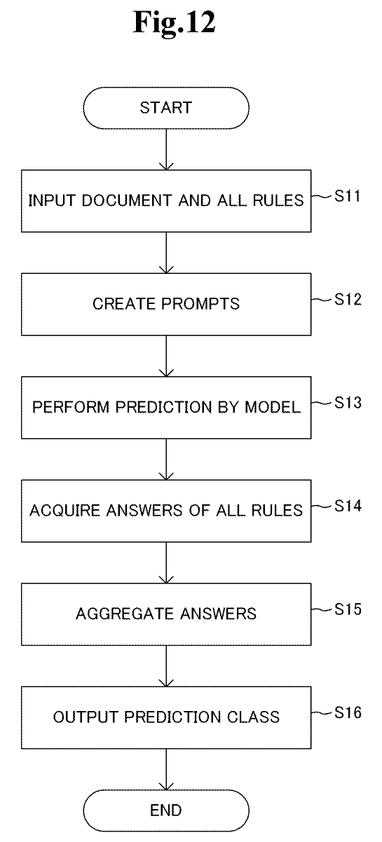

Next, configurations and operations of the prompt generation unit 11 and the inference unit 13 (the prediction unit 14 and the aggregation unit 15) will be described as a configuration and an operation at the time of inference using the language model by the information processing device 10. FIGS. 7 to 11 illustrate an example of processing by the information processing device 10, and FIG. 12 illustrates a flowchart of a processing operation by the information processing device 10.

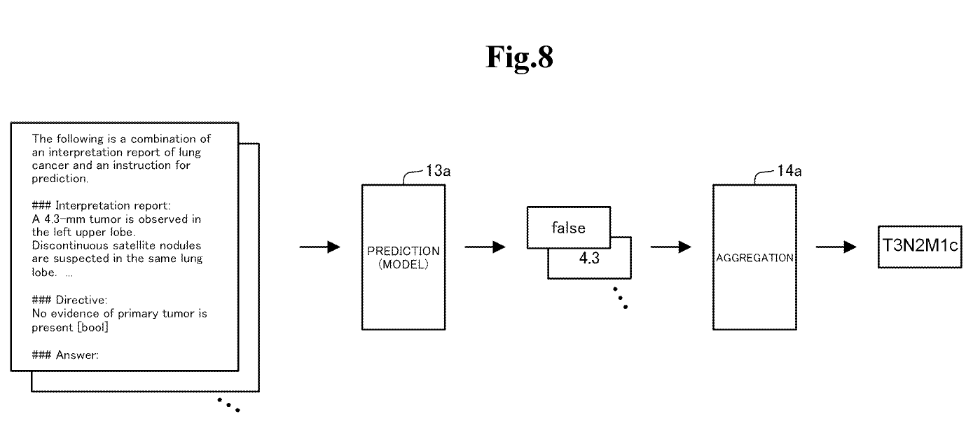

Similarly to the above, the prompt generation unit 11 receives inputs of the interpretation report being the document that is the classification target and all rules used at the time of the TNM-based classification (step S11 in FIG. 12). The prompt generation unit 11 then generates the prompts composed of the combinations of the interpretation report and the rules (reference sign 11a in FIG. 7, step S12 in FIG. 12). Specifically, as illustrated in FIG. 8, the prompt generation unit 11 generates, as the prompts, commands instructing the language model to perform prediction (inference), regarding the content of the “interpretation report” contained in the prompts, for the contents of the “rules” that are directives contained in the prompts, and to output answers that are prediction results (inference results). At this time, similarly to the above, the prompt generation unit 11 generates each prompt in such a way as to form a combination of one rule and the interpretation report with a correspondence relation. Thus, when there are 16 rules as illustrated in FIG. 2, 16 prompts are generated. In this way, one prompt is generated for each rule, which makes it possible to reduce an increase in the prompt length as described above, and to decrease the memory usage in the information processing device 10 and the amount of calculation by the language model according to the prompts.

The inference unit 13 inputs, to the language model M, the prompt created with a correspondence relation with each rule as described above, obtains, from the language model M, an answer to each rule regarding the interpretation report, and outputs a class obtained by classifying the interpretation report based on the answer to each rule. Specifically, the inference unit 13 first inputs, with the prediction unit 14, the prompts relevant to the respective rules, that is, the 16 prompts to the language model M (reference sign 13a in FIGS. 7 and 8). Then, the prediction, regarding the interpretation report, for each of the rules is performed for each prompt by the language model M, and answers 1 to n for the respective rules are output from the language model M as illustrated in FIG. 7 (step S13 in FIG. 12). This allows the prediction unit 14 to obtain the answers to all the rules for the interpretation report (step S14 in FIG. 12). For example, as illustrated in FIGS. 2 and 8, the prediction unit 14 obtains the answers composed of the values of “true”, “false”, and a “numerical value” individually for the rules. The prediction unit 14 may obtain the answers by inputting the prompts relevant to the respective rules to one language model subjected to the machine learning as described above, or may obtain the answers by inputting the prompts to respective language models relevant to the respective rules.

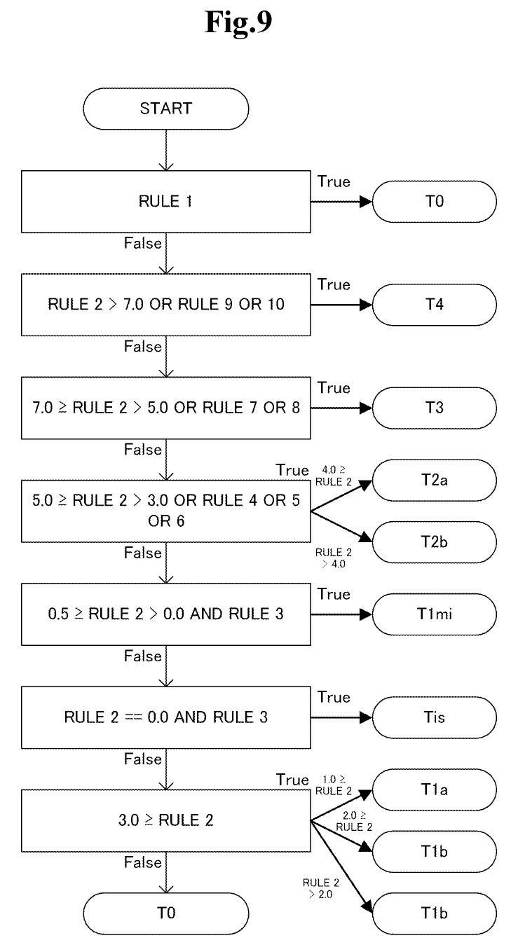

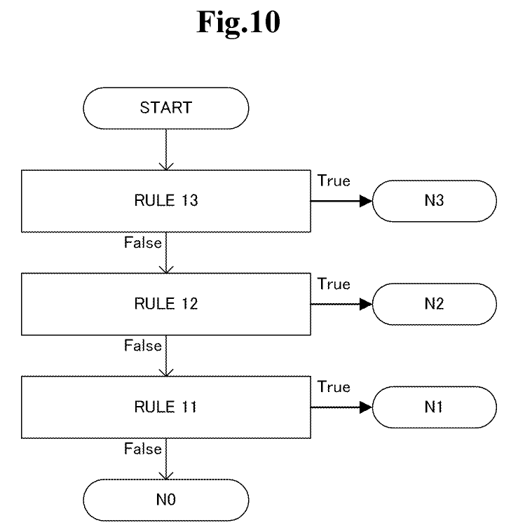

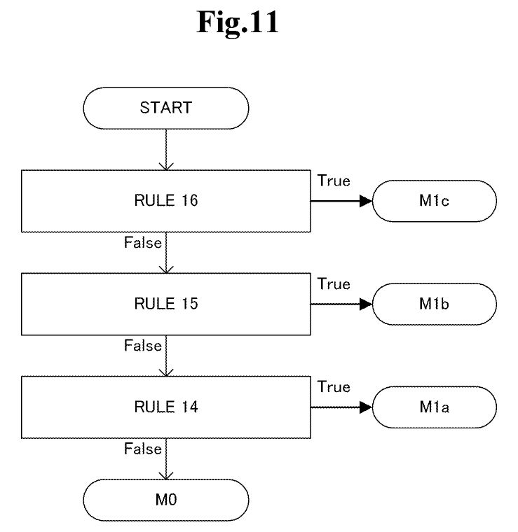

Subsequently, the aggregation unit 15 aggregates all the answers relevant to all the rules and outputs a prediction class obtained by predicting the classification of the interpretation report. Specifically, the aggregation unit 15 aggregates all the answers and calculates the prediction class in accordance with a preset rule (reference sign 14a in FIGS. 7 and 8, step S15 in FIG. 12). For example, as illustrated in FIGS. 9 to 11, a rule of the aggregation by the aggregation unit 15 for the answers is set using a rule base according to the answer value of each rule. As an example, FIG. 9 illustrates a rule base for the T classification in the TNM classification, in which the T classification (for example, T0, T4, and the like) is calculated according to the answers of Rules 1 to 10, that is, values of “true” and “false” and a “numerical value” with a correspondence relation with the individual rules. As another example, FIG. 10 illustrates a rule base for the N classification in the TNM classification, in which the N classification (for example, N1, N2, and the like) is calculated according to the answers to Rules 11 to 13. As another example, FIG. 11 illustrates a rule base for the M classification in the TNM classification, in which the M classification (for example, M1a, M1b, and the like) is calculated according to the answers to Rules 14 to 16.

Then, the aggregation unit 15 further aggregates the T classification, the N classification, and the M classification that are calculated as described above, and outputs a final prediction class (step S16 in FIG. 12). For example, as illustrated in “AFTER AGGREGATION" in FIG. 2, a prediction class “T3N2M1c” obtained by merging the classifications is output.

As described above, in the present example embodiment, since the prompt is generated for each rule utilized for the classification of the document that is the interpretation report, each prompt length can be shortened relative to the case where all the rules are contained in one prompt, and the amount of calculation of the language model for the prompt can be decreased. As a result, accuracy in the inference by the language model can be improved, and accuracy in the document classification can be improved. At this time, in particular, since the language model outputs one answer for each rule, the prediction becomes simpler than directly predicting the final prediction class of the document, and the prediction accuracy can be improved. Further, since the configuration is such that the answers for all the rules are output from the language model, prediction with excellent interpretability is feasible.

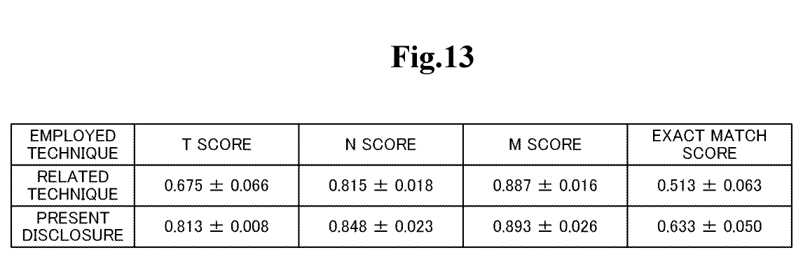

Here, FIG. 13 indicates average accuracy rates and their standard deviations for the technique of the present disclosure and the related technique, obtained by performing an experiment of the TNM-based classification of an interpretation report of lung cancer by using three language models. The related technique is assumed to be the case where a plurality of rules are collectively contained in a prompt as described above. For the T, N, and M scores, the accuracy rate is a ratio of data that can be correctly classified by each of the labels of T, N, and M among all the data. For exact match scores, the accuracy rate is a ratio of data in which all the labels of T, N, and M can be correctly classified among all the data. As indicated in this table, with the technique of the present disclosure, the exact match score is improved over the related technique, and particularly, the T score is significantly improved. As described above, according to the present disclosure, it is possible to improve the inference accuracy in document classification.

### Second example embodiment

Next, a second example embodiment of the present disclosure will be described. An information processing device 10 in the present example embodiment has a similar configuration as that of the first example embodiment described above, but is different from that of the first example embodiment in the following points. Hereinafter, a configuration different from the above will be mainly described.

The information processing device 10 according to the present example embodiment includes a prompt generation unit 11, an inference unit 13, and a model storage unit 16 of the configuration illustrated in FIG. 1. The model storage unit 16 stores a language model M already subjected to machine learning. That is, the information processing device 10 in the present example embodiment does not have the training function described in the first example embodiment, but has an inference function.

First, in the information processing device 10, the prompt generation unit 11 generates a prompt containing an interpretation report being a document that is a classification target and one rule, for each rule used at the time of TNM-based classification. The inference unit 13 then inputs the prompts for the respective rules to the language model subjected to the machine learning to acquire answers, and predicts a class of the interpretation report from all the answers.

In the present example embodiment, this allows the amount of calculation of the language model to decrease by shortening the prompts similarly to the above, which can contribute to improvement of the accuracy in the inference by the language model. As a result, the accuracy in the document classification can be improved.

In the present example embodiment, the case where the information processing device 10 includes only the configuration for the time of the inference is exemplified; however, the information processing device 10 may include only the configuration for the time of training. That is, the information processing device may include the prompt generation unit 11, a training unit 12, and the model storage unit 16 described earlier. Similarly to the above, this allows the information processing device 10 to generate a prompt for each rule and train the language model via machine learning by using an answer of the language model to the prompt and ground truth data for each rule.

### Third example embodiment

In the above example embodiments, the “interpretation report” is the classification target as the document; however, in the present example embodiment, a document with any content may be a classification target. In the present example embodiment, the document is not limited to being subjected to the above TNM-based classification, and any classification may be performed based on a plurality of rules according to a content of classification.

As an example, the present example embodiment is also applicable to an application in the medical field, in which the document is a medical record, and from several rules that support diagnosis prediction of a certain disease and prediction of a medical condition, prediction values (answers), regarding the medical record, to the rules are obtained, then final prediction (classification) of the disease, the medical condition, and the like is performed. This makes it applicable to supporting decision-making, such as doctor's diagnosis, using the answers obtained from the rules.

### Fourth example embodiment

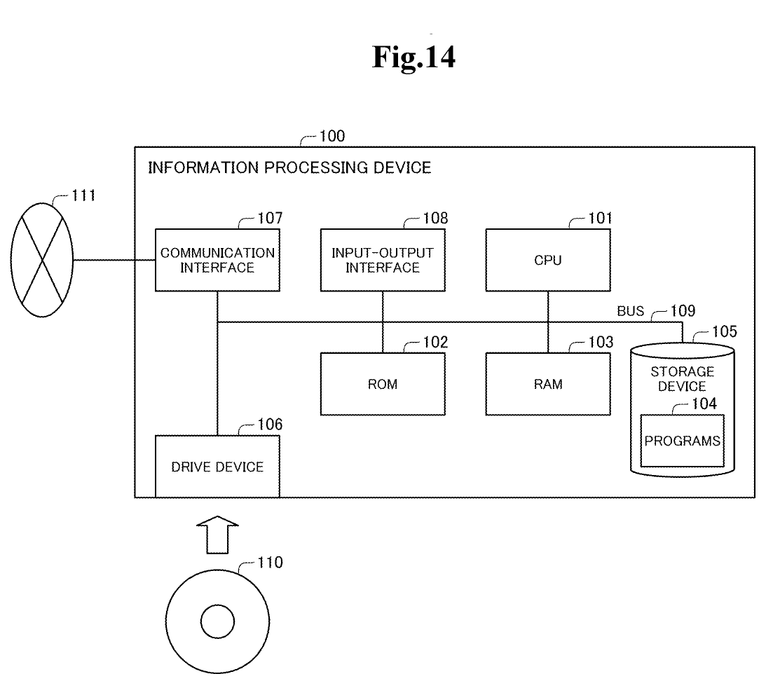

Next, a fourth example embodiment of the present disclosure will be described with reference to FIGS. 14 to 16. In the present example embodiment, an outline of the information processing device and the like described in the above example embodiments will be illustrated. FIGS. 14 to 16 can be related to all the example embodiments.

First, a hardware configuration of an information processing device 100 according to the present disclosure will be described. The information processing device 100 is configured with a general information processing device and, in one example, is equipped with the hardware configuration below, as illustrated in FIG. 14.

Central processing unit (CPU) 101 (arithmetic device)

Read-only memory (ROM) 102 (storage device)

Random-access memory (RAM) 103 (storage device)

Programs 104 to be loaded into the RAM 103

Storage device 105 storing the programs 104

Drive device 106 for performing reading and writing on a storage medium 110 outside the information processing device

Communication interface 107 connected to a communication network 111 outside the information processing device

Input-output interface 108 for inputting and outputting data

Bus 109 for connecting the components

FIG. 14 illustrates an example of the hardware configuration of the information processing device that is the information processing device 100, and the hardware configuration of the information processing device is not limited to the above. For example, the information processing device may be configured with a part of the above configuration, such as not including the drive device 106. Instead of the CPU described above, the information processing device can use a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

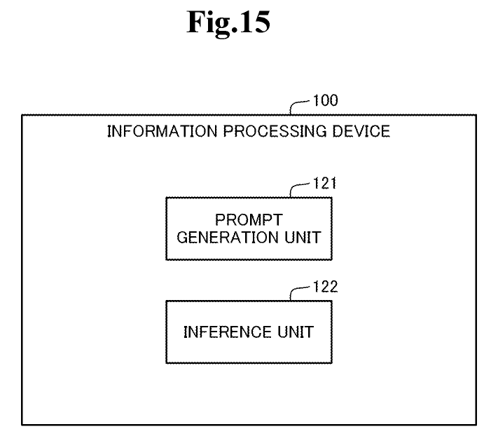

The CPU 101 acquires and executes the programs 104, whereby the information processing device 100 can construct and equip a prompt generation unit 121 and an inference unit 122 that are illustrated in FIG. 15. The programs 104 are stored, for example, in the storage device 105 and/or the ROM 102 in advance, and the CPU 101 loads and executes the programs 104 on the RAM 103, as necessary. The programs 104 may be supplied to the CPU 101 via the communication network 111, or the drive device 106 may read the programs stored in the storage medium 110 in advance and supply the programs to the CPU 101. The prompt generation unit 121 and the inference unit 122 described above may be constructed by dedicated electronic circuits for achieving their means.

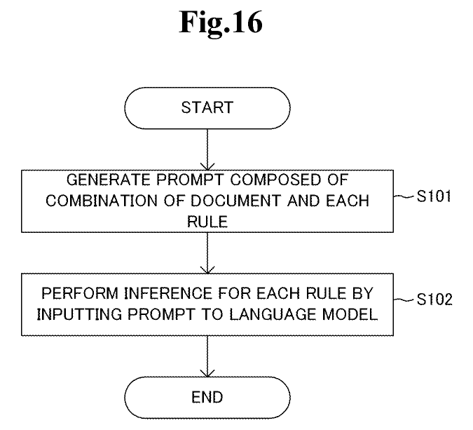

The prompt generation unit 121 described above generates a prompt composed of a combination of a document and a rule, for each individual rule among a plurality of the rules for classifying the document into a preset class (step S101 in FIG. 16). The inference unit 122 described above performs, with a language model, inference for each rule of the document by inputting each prompt to the language model (step S102 in FIG. 16).

In the above configuration, the information processing device 100 first generates the prompt composed of the document that is a classification target and one rule, for each rule used at the time of classifying the document. The information processing device 100 then inputs the prompts generated for the respective rules to the language model subjected to machine learning to obtain individual inference results. This allows the information processing device 100 to decrease the amount of calculation of the language model by shortening the prompts, which can contribute to improvement of accuracy of the inference results for the respective prompts. As a result, the accuracy in the document classification based on the inference results of the respective prompts can be improved.

At least one or more of the functions of the prompt generation unit 121 and the inference unit 122 described above may be executed by an information processing device installed and connected at any place on a network, that is, may be executed by what is called cloud computing.

The programs described above can be stored using various types of non-transitory computer-readable media and supplied to a computer. The non-transitory computer-readable media include various types of tangible storage media. Examples of the non-transitory computer-readable media include a magnetic recording medium (for example, a flexible disk, a magnetic tape, and a hard disk drive), an optical magnetic recording medium (for example, a magneto-optical disk), a compact disc read-only memory (CD-ROM), a compact disc recordable (CD-R), a compact disc rewritable (CD- R/W), and a semiconductor memory (for example, a mask ROM, a programmable ROM (PROM), an erasable PROM (EPROM), a flash ROM, and a random-access memory (RAM)). The programs may also be supplied to the computer by various types of transitory computer-readable media. Examples of the transitory computer-readable media include electrical signals, optical signals, and electromagnetic waves. The transitory computer-readable media can supply the programs to the computer via a wired or wireless communication path, such as wires and optical fibers.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other embodiments.

### Supplementary Notes

One, some, or all of the above example embodiments may be described as in the following Supplementary Notes. Hereinafter, outlines of configurations of the information processing device, the information processing method, and the program according to the present disclosure will be described. However, the present disclosure is not limited to the configurations described in the following Supplementary Notes.

One, some, or all of the configurations described in Supplementary Notes 2 to 6 dependent from Supplementary Note 1 described below and the functions according to those configurations can also be dependent from other Supplementary Notes 7 and 9 by a dependency relation similar to those of Supplementary Notes 2 to 6. Moreover, one, some, or all of the configurations described as Supplementary Notes and the functions according to those configurations can be similarly dependent from not only Supplementary Notes 1, 7, and 9, but also various pieces of similar hardware and software, and various types of recording means for recording the software, or systems without departing from the above-described example embodiments.

### Supplementary Note 1

An information processing device including:

a prompt generation unit that generates a prompt composed of a combination of a document and a rule, for each individual rule among a plurality of the rules for classifying the document into a preset class; and

an inference unit that performs, with a language model, inference for each of the rules of the document by inputting each of the prompts to the language model.

### Supplementary Note 2

The information processing device according to Supplementary Note 1, in which the inference unit outputs a class obtained by classifying the document based on an inference result for each of the rules.

### Supplementary Note 3

The information processing device according to Supplementary Note 1, in which the prompt generation unit generates, for each of the rules, the prompt containing the document and one of the rules and composed of a command to perform inference, regarding the document, for the one of the rules.

### Supplementary Note 4

The information processing device according to Supplementary Note 3, in which the inference unit performs inference with each of a plurality of the language models by inputting each of the prompts containing the rules that are relevant, to each of the language models prepared for the respective rules with correspondence relations.

### Supplementary Note 5

The information processing device according to Supplementary Note 1, further including a training unit that trains the language model via machine learning based on inference results obtained by inputting the prompts to the language model and based on pieces of ground truth data for the rules of the document contained in the prompts.

### Supplementary Note 6

The information processing device according to Supplementary Note 5, in which the training unit trains each of a plurality of the language models via machine learning based on each of the inference results obtained by inputting, to each of the language models relevant to each of the rules, each of the prompts containing the rules that are relevant, and based on each of the pieces of ground truth data for the rules of the document contained in the respective prompts.

### Supplementary Note 7

An information processing method in which an information processing device performs:

generating a prompt composed of a combination of a document and a rule, for each individual rule among a plurality of the rules for classifying the document into a preset class; and

performing, with a language model, inference for each of the rules of the document by inputting each of the prompts to the language model.

### Supplementary Note 7.1

The information processing method according to Supplementary Note 7, in which the information processing device performs outputting a class obtained by classifying the document based on an inference result for each of the rules.

### Supplementary Note 7.2

The information processing method according to Supplementary Note 7, in which the information processing device performs generating, for each of the rules, the prompt containing the document and one of the rules and composed of a command to perform inference, regarding the document, for the one of the rules.

### Supplementary Note 8

The information processing method according to Supplementary Note 7, in which the information processing device trains the language model via machine learning based on inference results obtained by inputting the prompts to the language model and based on pieces of ground truth data for the rules of the document contained in the prompts.

### Supplementary Note 9

A program causing an information processing device to execute processing to:

generate a prompt composed of a combination of a document and a rule, for each individual rule among a plurality of the rules for classifying the document into a preset class; and

perform, with a language model, inference for each of the rules of the document by inputting each of the prompts to the language model.

### Supplementary Note 10

The program according to Supplementary Note 9, the program causing the information processing device to execute processing to train the language model via machine learning based on inference results obtained by inputting the prompts to the language model and based on pieces of ground truth data for the rules of the document contained in the prompts.

### Reference Signs List

10 information processing device

11 prompt generation unit

12 training unit

13 inference unit

14 prediction unit

15 aggregation unit

16 model storage unit

100 information processing device

101 CPU

102 ROM

103 RAM

104 programs

105 storage device

106 drive device

107 communication interface

108 input-output interface

109 bus

110 storage medium

111 communication network

121 prompt generation unit

122 inference unit

1. A document classification device using a language model comprising:
at least one memory configured to store processing instructions; and at least one processor configured to execute the processing instructions to:
generate a prompt composed of a combination of a document and a rule, for each individual rule among a plurality of the rules for classifying the document into a preset class;
perform, with the language model, inference for each of the rules of the document by inputting each of the prompts to the language model, and output a class obtained by classifying the document based on an inference result for each of the rules; and
in a case where training the language model via machine learning based on inference results obtained by inputting the prompts to the language model and based on pieces of ground truth data for the rules of the document contained in the prompts, train each of a plurality of the language models via machine learning based on each of the inference results obtained by inputting, to each of the language models relevant to each of the rules, each of the prompts containing the rules that are relevant, and based on each of the pieces of ground truth data for the rules of the document contained in the respective prompts.

2. The document classification device using the language model according to claim 1, the at least one processor is configured to execute the processing instructions to generate, for each of the rules, the prompt containing the document and one of the rules and composed of a command to perform inference, regarding the document, for the one of the rules.

3. The document classification device using the language model according to claim 2, wherein the at least one processor is configured to execute the processing instructions to perform inference with each of the language models, by inputting each of the prompts containing the rules that are relevant, to each of the language models prepared for the respective rules with correspondence relations.

4. A document classification method using a language model, wherein an information processing device performs:
generating a prompt composed of a combination of a document and a rule, for each individual rule among a plurality of the rules for classifying the document into a preset class;
performing, with the language model, inference for each of the rules of the document by inputting each of the prompts to the language model, and outputting a class obtained by classifying the document based on an inference result for each of the rules; and
in a case where training the language model via machine learning based on inference results obtained by inputting the prompts to the language model and based on pieces of ground truth data for the rules of the document contained in the prompts, training each of a plurality of the language models via machine learning based on each of the inference results obtained by inputting, to each of the language models relevant to each of the rules, each of the prompts containing the rules that are relevant, and based on each of the pieces of ground truth data for the rules of the document contained in the respective prompts.

5. The document classification method using the language model according to claim 4, wherein the information processing device performs generating, for each of the rules, the prompt containing the document and one of the rules and composed of an instruction to perform inference, regarding the document, for the one of the rules.

6. The document classification method using the language model according to claim 5, wherein the information processing device performs performing inference with each of the language models by inputting, each of the prompts containing the rules that are relevant, to each of the language models prepared for the respective rules with correspondence relations.

7. A non-transitory computer-readable storage medium storing a program causing an information processing device to execute processing to:
generate, a prompt composed of a combination of a document and a rule, for each individual rule among a plurality of the rules for classifying the document into a preset class;
perform, with a language model, inference for each of the rules of the document by inputting each of the prompts to the language model, and outputting a class obtained by classifying the document based on an inference result for each of the rules; and
in a case where training the language model via machine learning based on inference results obtained by inputting the prompts to the language model and based on pieces of ground truth data for the rules of the document contained in the prompts, train each of a plurality of the language models via machine learning based on each of the inference results obtained by inputting, to each of the language models relevant to each of the rules, each of the prompts containing the rules that are relevant, and based on each of the pieces of ground truth data for the rules of the document contained in the respective prompts.

8. The non-transitory computer-readable storage medium according to claim 7, the computer-readable storage medium storing a program causing the information processing device to execute processing to generate, for each of the rules, the prompt containing the document and one of the rules and composed of an instruction to perform inference, regarding the document, for the one of the rules.

9. The non-transitory computer-readable storage medium according to claim 8, the computer-readable storage medium storing a program causing the information processing device to execute processing to perform inference with each of the language models by inputting, each of the prompts containing the rules that are relevant, to each of the language models prepared for the respective rules with correspondence relations.
